(19) United States
(12) Patent Application Publication
(10) Pub. No.: US 2026/0162550 A1
(43) Pub. Date: Jun. 11, 2026

(54) Virtual Race Coach

(71) Applicant: Vincent Loccisano, Wellesley, MA (US)

(72) Inventor: Vincent Loccisano, Wellesley, MA (US)

(21) Appl. No.: 19/537,870

(22) Filed: Feb. 12, 2026

(51) Int. Cl. G09B 5/02; G09B 29/00

(52) U.S. Cl. CPC G09B 5/02; G09B 29/003

(57) ABSTRACT

The present disclosure describes a virtual race coach system and method configured to improve driver performance through advanced telemetry analysis. The system captures time-stamped vehicle data—including position, speed, acceleration, and driver inputs—and compares it against a repository of reference trajectories, such as expert laps or computed optimal paths. By utilizing a vehicle-specific performance profile, the system aligns the telemetry with reference data to calculate deviations and generates targeted coaching recommendations. These recommendations are prioritized based on estimated benefits and presented to the user via real-time interfaces (such as augmented reality overlays or audio) or post-session analysis.

### TECHNICAL FIELD OF THE INVENTION

The present invention relates, generally, to driver coaching and vehicle performance optimization, and more particularly to systems and methods for providing a virtual coach that uses telemetry and vehicle-specific models to coach drivers on how to traverse a racecourse.

### BACKGROUND OF THE INVENTION

High-performance driving and racing require precise control of vehicle dynamics, including braking, throttle application, steering, and line selection. Traditionally, drivers have improved their skills through seat time and subjective feedback from human instructors. While effective, human instruction is resource-intensive, expensive, and not always available.

Modern data acquisition systems are capable of recording vast amounts of telemetry data including GPS position, speed, and internal sensor readings from a vehicle's Controller Area Network (CAN) bus. Existing solutions typically present this data as raw traces, showing speed versus distance graphs, or simple delta-time comparisons, showing whether a driver is faster or slower than a referenced lap.

Current systems suffer from significant limitations. Interpreting raw telemetry traces requires a high level of technical expertise that many amateur drivers lack. Merely knowing where time was lost does not necessarily inform a driver how to recover the lost time. Real-time feedback in current systems is often limited to a predictive lap timer that displays a time delta. This simple metric can encourage over-driving without offering specific guidance on corrective action.

There remains a need for an automated system capable of contextualizing telemetry data against vehicle capabilities to provide actionable specific coaching recommendations.

### SUMMARY OF THE INVENTION

Embodiments of the present disclosure relate generally to automotive telemetry and driver training, and more specifically to a virtual race coach system capable of analyzing vehicle dynamics to provide actionable feedback.

In an example embodiment, a system is provided comprising a telemetry acquisition module, a reference trajectory store, a vehicle profile store, a comparison engine, and a coaching engine. The telemetry acquisition module is configured to receive data from a vehicle traversing a racecourse. Data collected may include metrics such as vehicle position, speed, longitudinal and lateral acceleration, steering angle and driver input signals. They system utilizes a vehicle profile store containing performance parameters specific to the vehicle in use, alongside a reference trajectory store containing data sets such as previously recorded laps, expert driver laps, or physics-based optimized trajectories.

The comparison engine is configured to spatially align the received telemetry data with a selected reference data set, utilizing techniques such as arc-length indexing or dynamic time warping to compute differences across specific track segments. The coaching engine generates recommendations based on these computed differences and the vehicle-specific limitations. These recommendations are presented through a user interface module in real-time, near-real-time or post-session modules.

Further features of the disclosure enhance the system's capabilities through high-granularity data acquisition, such as collecting wheel slip and tire temperature to refine performance analysis. To ensure accurate comparisons between laps driven at varying speeds, the system employs advanced spatial alignment and resampling techniques based on arc length. The coaching logic is bolstered by machine-learned models trained on expert data to map telemetry deviations to specific actions, alongside physics-based optimizers that compute theoretical best trajectories. These recommendations are delivered through diverse feedback modalities, including audio prompts, haptic feedback, and augmented reality (AR) overlays that display racing lines and braking zones. Additionally, the system quantifies potential improvements by providing confidence scores and estimated lap-time reductions for each recommendation, thereby aiding the driver in prioritizing adjustments.

In another example embodiment a method for coaching a driver is provided. The method involves receiving time-stamped telemetry during a session and selecting a reference data set conditioned on the vehicle profile and a specific driver goal. Specific driver goals may include minimal lap time, consistency, or conservation, for example. The method spatially aligns the telemetry with the reference data to calculate per-segment deviations. Using a vehicle-specific performance model, the method computes the estimated benefit of various candidate corrective actions and outputs the most impactful coaching recommendations to the driver.

### BRIEF DESCRIPTION OF DRAWINGS

FIG. 1 is a block diagram depicting the system overview.

FIG. 2 is an illustration depicting a track map overlay showing an example driver lap compared to an expert/optimized lap.

FIG. 3 depicts a real-time coaching loop timing diagram.

FIG. 4 depicts a user interface example showing coach dashboard wireframe with synchronized telemetry plots, video, map and a recommendations panel.

FIG. 5 is a flowchart for vehicle profile system identification and model tuning.

### DETAILED DESCRIPTION OF THE INVENTION

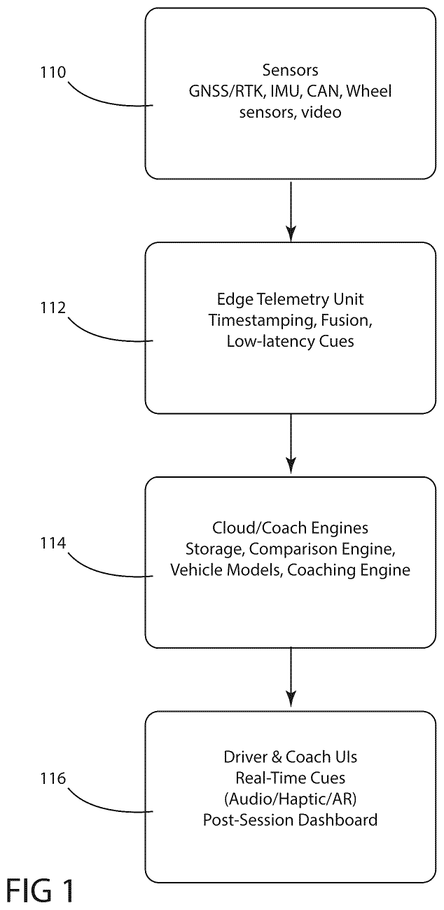

In FIG. 1 an example embodiment of a block diagram depicting the system overview is shown. Sensors 110 in a vehicle may include Global Navigation Satellite System (GNSS) in combination with a Real-Time Kinematic technology (RTK), also referred to as GNSS/RTK at 5-100+ Hz. The GNSS/RTK sensors work in further combination with an Inertial Measurement Unit (IMU) at 100-2000+ HZ. This combination of GNSS/RTK with IMU sensors precisely locates a vehicle with respect to a track. Additional sensors include wheel-speed sensors, steering-angle sensor, throttle position, brake pressure/pedal travel sensor, engine RPM, gear selector, clutch state, tire pressure/temperature sensors, CAN-bus signals, and forward/cockpit cameras. In some embodiments trackside beacons are used to calibrate sensors and location of the vehicle.

An edge telemetry unit 112 is configured to time-stamp sensor streams through GNSS PSS or fused clock. The term GNSS PPS refers to a highly precise timing signal called Pulse Per Second, which is generated by Global Navigation Satellite System receivers. A “fused clock” generally describes a system where the GNSS timing information is combined with a local oscillator or other timing sources to create a highly accurate and stable time reference. GNSS and IMU are used in combination with a Kalman filter variant to achieve a more accurate and robust position, velocity, and orientation estimate. The EKF (Extended Kalman Filter) and UKF (Unscented Kalman Filter) are two specific types of Kalman filters used for this fusion, with the UKF often outperforming the EKF in this application.

In some embodiments time synchronization through GNSS and PPS is preferred. In other embodiments a Precision Time Protocol (PTP) or a cross-correlation and software clock fusion are used. Per-sample confidence metrics are then generated.

One skilled in the art understands that many of the aforementioned sensors may exist in a vehicles' CANbus and sensor information may be available in CANbus data. In some embodiments additional sensors may be added to a vehicle in vehicle mounted hardware.

A Cloud/Coach Engine 114 is a subsystem that initiates its analysis through a preprocessing and feature extraction phase wherein sensor fusion produces position and velocity estimates. To capture the dynamic state of the vehicle, they system computes derived signals such as longitudinal and lateral acceleration, yaw rate, wheel slip ratio, estimated slip angle and steering rate, alongside driver inputs like throttle and brake derivatives, gearshift events and pedal pressures. A critical component of this phase is arc-length indexing, which calculates the cumulative distance traveled along the driven path to facilitate robust spatial alignment between laps regardless of speed or time profile differences. The stream is further processed through event and segment detection algorithms that utilize curvature and speed thresholds to identify key track features—including braking onsets, turn entries, apex windows, exits, and straights—tagging each with relevant metadata. Simultaneously, rigorous quality checks are applied to flag GPS dropouts, saturated sensors, or implausible values, computing per-sample confidence levels before the data is bundled into canonical telemetry packages containing vehicle profile IDs, session metadata, checksums, and optional synchronization markers for video alignment.

Following processing, data management is handled through a secure storage and transmission architecture. Data is initially secured in a local encrypted file store on the edge unit, which manages transmission to the cloud via chunked uploads over Wi-Fi or 5G networks with built-in resume support to handle connectivity interruptions. On the server side, a cloud environment comprising object storage and time-series databases indexes the data by track, arc-length position, and session metadata.

The analytical precision of the system relies on a comprehensive repository of reference data and detailed vehicle profiles. The reference data sources include a driver's own historical benchmarks, such as best laps or session averages, as well as external standards like curated expert driver laps or AI-generated optimized trajectories derived from track constraints and vehicle models. These references are contextualized by specific vehicle profiles that house essential parameters including mass, center-of-gravity location, aerodynamic coefficients, tire model parameters, braking performance maps, and drivetrain latency. These parameters may be sourced from manufacturer specifications, manual user input, or empirical estimation. Crucially, the system includes a vehicle model tuning module that utilizes recorded telemetry and system identification routines—such as least squares, extended Kalman filters, or gradient-based optimization —to dynamically refine estimates of tire stiffness, drag, and effective rolling radius, updating the stored profile for more accurate future coaching.

The core intelligence of the system resides in the interaction between the comparison engine and the coaching engine. The comparison engine spatially aligns the current telemetry to a selected reference using the previously generated arc-length indexing, employing dynamic time warping if necessary to ensure precise geometric correspondence. It then computes granular differences across the track surface, analyzing variables such as speed, braking onset points, pedal profiles, steering angles, and slip angles. At a higher level, segment-specific metrics are calculated for entry, apex, and exit speeds, as well as time-in-turn and predicted time deltas. These metrics feed into the coaching engine, which synthesizes the deltas, vehicle profile constraints, and specific driver goals—ranging from lap time minimization to tire conservation. This engine employs a hybrid approach: a rules-based module handles deterministic corrections, a model-based optimizer simulates counterfactual scenarios to estimate the physics-driven impact of input changes, and a machine-learning module—utilizing sequence models like LSTMs or Transformers—maps complex deviations to recommended actions based on expert patterns. The final output consists of prioritized recommendations complete with rationales, confidence scores, estimated lap-time improvements, and specific drill suggestions to guide driver development.

To facilitate seamless interaction between the system and its users, a standardized user interface architecture 116 is employed. This relies on a canonical data package that utilizes arc-length-indexed telemetry, consolidating fields such as position, speed, acceleration, steering, throttle, brake status, wheel speeds, tire temperatures, RPM, and gear selection into a unified format marked with event metadata. Access to this data is managed through robust APIs, including REST and gRPC endpoints for retrieving raw telemetry, derived signals, reference sets, and session summaries, alongside WebSocket streams for real-time data transmission.

For human coaches, the dashboard provides a comprehensive visualization suite featuring track map overlays with lap comparisons and time-delta heatmaps. Synchronized time-series plots display critical variables like speed, throttle, and yaw, while video playback is tightly synced with telemetry to allow for precise scrubbing. The interface includes segment lists highlighting prioritized gains and annotation tools for marking braking zones or adding notes, enabling coaches to edit recommendations and push drill plans directly to the driver. Complementing human oversight, the AI coach interface processes the canonical telemetry against vehicle profiles and driver goals to generate ranked recommendations and natural-language summaries. It supports a human-in-the-loop workflow where AI suggestions are validated by a human coach before being transmitted or sent directly once confidence thresholds are met.

The virtual coach system communicates directly with the driver during operation through a prioritized, low-latency, and safety-aware multi-channel interface. This communication ecosystem utilizes a diverse array of hardware, including helmet communications or low-latency race radios for voice prompts, in-car audio systems, and augmented reality HUDs or windshield overlays that project visual guidance like racing lines and braking zones with minimal clutter. Tactile feedback is provided through haptic actuators in the steering wheel, seat, or pedals to signal directional cues or urgency, while lightweight wearable devices or dashboard displays offer supplementary visual prompts. Connectivity is maintained via dedicated low-latency wireless links such as Wi-Fi Direct or Bluetooth LE, falling back to LTE or 5G networks when local connections are unavailable, ensuring message delivery meets strict timing requirements—ideally less than 300 milliseconds for immediate cues.

The system categorizes messages into distinct types, ranging from pre-turn advisories regarding braking distances and target speeds to corrective cues like “trail-brake” or “tighten line.” Critical safety alerts for imminent collisions, high slip, or loss of control always take precedence, overriding non-critical cues. To manage the driver's cognitive load, the system employs sophisticated prioritization logic—ranking safety alerts above corrective cues and preparatory advisories—and applies suppression rules to withhold verbose or low-priority messages during high-intensity maneuvers or incident recovery. Messages are timed to arrive sufficiently in advance for advisories (0.5 to 3 seconds), or within milliseconds for immediate corrections, utilizing aggregation techniques to combine multiple suggestions into concise prompts.

Decision-making responsibilities are distributed between edge and cloud resources to optimize performance. Critical, low-latency decisions are processed on the onboard edge unit to ensure immediate response, while complex, compute-intensive optimization is handled remotely in the cloud. This hybrid approach allows for personalization, where drivers can select preferred feedback channels and verbosity levels, or coaches can override settings for specific drills. Throughout operation, the system adheres to strict safety protocols, ensuring cues remain advisory without intervening in vehicle control, implementing emergency suppression during incidents, and logging all interactions for post-session analysis.

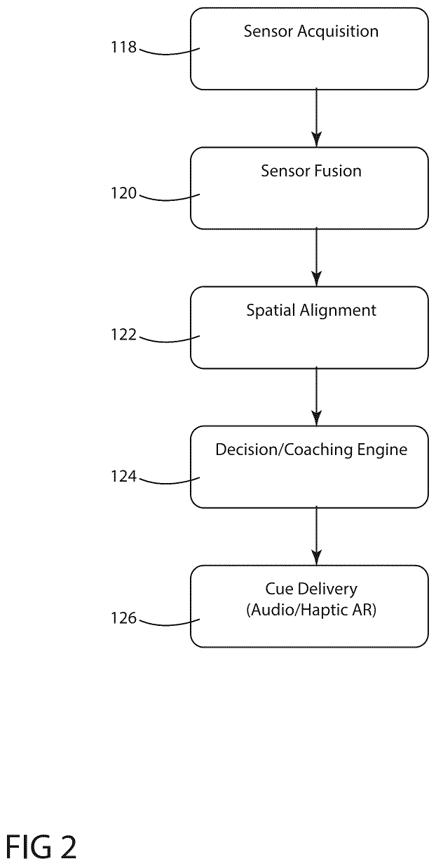

FIG. 2 summarizes the real-time coaching loop. Sensor acquisition 118 includes the gathering data from the sensors and driver cues. In Sensor Fusion 120, the system analyzes the data and combines the sensor data with Spatial Alignment 122 to inform the Coaching Engine 124 that in turn displays results as Cue Delivery 126 in the user interface.

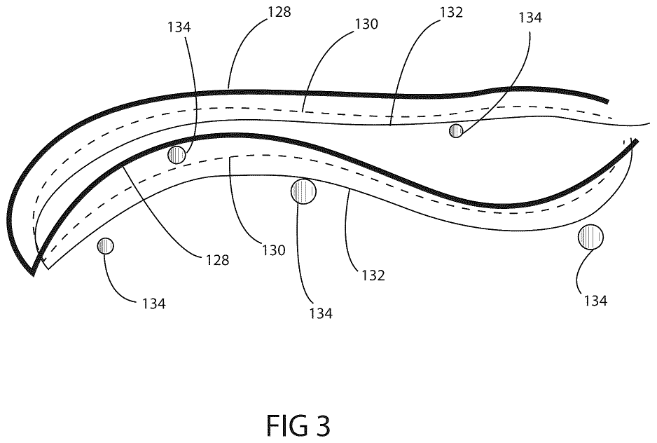

FIG. 3 illustrates an example use case. A track boundary is depicted by line 128 in the two cases shown. A dashed line 130 in each example use case depicts a reference driving line. The solid line 132 depicts the drive line of the driver in training. Time difference between the expert driver line 130 and the driver in training line 132 are shown by heat maps 134. Heat maps are illustrated in this example as shaded areas whereas a color display could show the heat map in a color range from green to red, for example. One skilled in the art is familiar with similar heat map illustrations showing time-delta and the like.

In an example embodiment, a pre-turn braking scenario may occur as follows: as the vehicle approaches a corner, a HUD displays a countdown at 60 meters, followed by a short audio cue to brake at 20 meters, accompanied by a left steering-wheel LED flash if a tighter line is recommended. In instances of handling instability, such as understeer, the system provides immediate feedback via a brief haptic pulse in the seat or steering wheel, while simultaneously logging an unobtrusive visual icon for post-turn review. The system also supports structured drill sessions where a coach initiates a “braking practice” mode, prompting the edge unit to apply specific start/stop cues and repetition counts while tracking compliance.

Upon completion of a session computational processes are moved to the Cloud for analysis. In some embodiments this analysis includes optimized trajectory computations, machine learning inference, and counterfactual simulations.

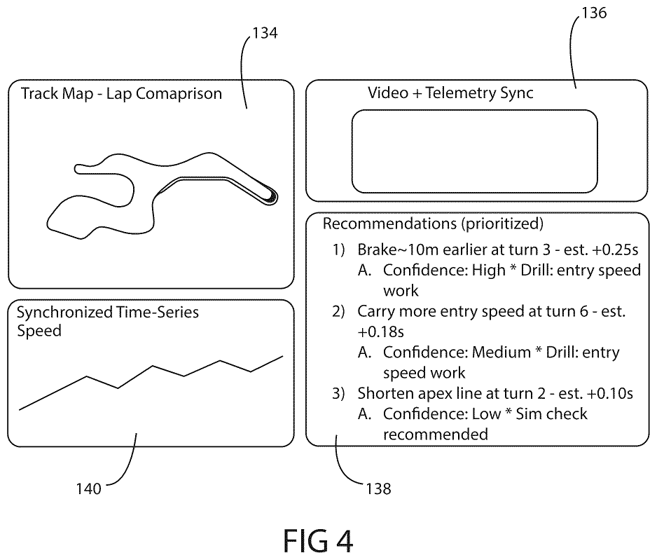

The illustration in FIG. 4 is an example of a user interface displaying such results in the form of comprehensive deliverables. The user interface includes a track map and lap comparison 134. This track map may include specific details as illustrated in FIG. 3. a video and telemetry synchronization window 136 is configured to show videos of the details from the track map 134. A synchronized time-series speed map 140 provides a graphic overview of a driver's speed throughout the track. Prioritized recommendations are listed in the recommendations window 138 along with estimated time gains. These insights are accessible via web dashboards or mobile apps, allowing human coaches to add notes or push edited drill packs. This creates a hybrid workflow where real-time cues address immediate errors, while post-session analysis drives long-term improvement by refining vehicle profiles and reference trajectories for future sessions. Furthermore, human feedback on AI suggestions serves to retrain the machine learning models, creating a continuous improvement loop.

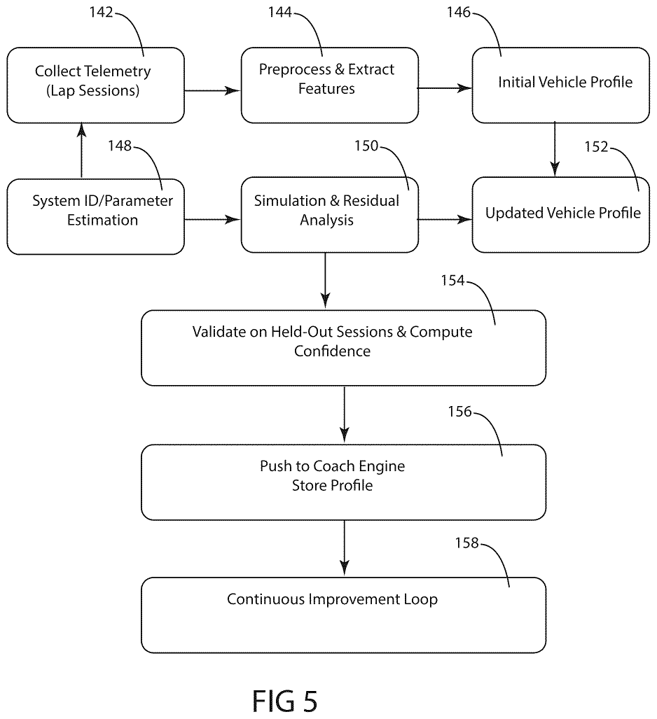

FIG. 5 is a diagram describing a method of using an example embodiment. The system begins with a system ID and parameter estimation 148 and then collects telemetry of lap sessions 142 and follows by reprocessing and extracting features 144 derived from the telemetry data collected during the lap sessions 142. The system uses this information to create an initial vehicle profile 146. Using the system ID and parameter estimation 148, the system creates a simulation and residual analysis 150 to create an updated vehicle profile 152. The simulation and residual analysis are used to validate on held-out sessions and to compute confidence 154. The process follows with a push to coach engine and then stores a profile 156 and finishes with a continuous improvement loop 158.

1. A virtual race coach system for telemetry-based driver training, comprising:
a telemetry acquisition module configured to receive time-stamped telemetry data from a vehicle, the telemetry data including vehicle position, velocity, and driver input signals; and
a vehicle profile store comprising a set of mechanical parameters and performance limits specific to the vehicle; and
a reference trajectory store comprising at least one reference data set representing a target traversal of a racecourse; and
a comparison engine configured to spatially align the received telemetry data with the selected reference data set using arc-length indexing and to compute telemetry deviations across corresponding track segments; and
a coaching engine configured to generate prioritized coaching recommendations based on the computed telemetry deviations and the vehicle profile; wherein the coaching engine estimates a performance benefit for each recommendation.

2. The system of claim 1 further comprising:
a user interface module configured to present the prioritized coaching recommendations to a driver via at least one of an audio interface, a haptic feedback device, or an augmented reality display in at least one of: real-time, near-real-time, or post-session modes.

3. The system of claim 1 wherein:
the telemetry acquisition module further collects wheel slip and tire temperature data.

4. The system of claim 1 wherein:
the coaching engine comprises a machine-learned model trained on expert laps to map telemetry deviations and vehicle parameters to coaching actions.

5. The system of claim 1 wherein:
the system comprises a hybrid architecture including: an edge computing unit located within the vehicle configured to perform low-latency spatial alignment and generate real-time safety cues; and
a cloud-based processing unit configured to perform post-session optimization and machine learning inference to refine the reference data set.

6. The system of claim 1 wherein:
the comparison engine is configured to normalize the telemetry data and the reference data set by calculating a cumulative distance along a driven path, thereby enabling spatial alignment between laps driven at different speeds.

7. The system of claim 2 wherein:
the user interface module is configured to suppress the presentation of coaching recommendations during detected high-cognitive-load events or vehicle instability, prioritizing safety alerts over performance advisories.

8. The system of claim 1 wherein:
the coaching engine includes a machine learning model trained on expert driver data, the model configured to map the computed telemetry deviations to specific corrective driver actions.

9. The system of claim 1 wherein:
the reference data set includes an optimized trajectory computed using a physics-based optimizer constrained by the vehicle-specific performance parameters.

10. The system of claim 1 wherein:
the comparison engine performs arc-length indexing and dynamic time warping to spatially align the telemetry data to the reference data.

11. A method for coaching a driver to traverse a racecourse using vehicle telemetry, the method comprising:
receiving, via a telemetry acquisition module, real-time data representing a vehicle's dynamic state and driver inputs; and
retrieving a vehicle profile containing physical performance parameters of the vehicle; and
selecting a reference trajectory corresponding to a current track segment; and
spatially aligning the real-time data with the reference trajectory based on arc-length position; and
calculating deviations between the real-time data and the reference trajectory; and
determining a corrective action based on the calculated deviations and the vehicle profile; and
outputting a coaching recommendation corresponding to the corrective action to the driver via a feedback user interface.

12. The method of claim 11 wherein:
outputting the coaching recommendation comprises delivering a haptic pulse to a steering wheel or seat to indicate a handling correction or braking point.

13. The method of claim 11 further comprising:
calculating a confidence score for the determined corrective action; and suppressing the coaching recommendation if the confidence score is below a predetermined threshold.

14. The method of claim 11 wherein:
the corrective action is derived by simulating a counterfactual trajectory using a physics-based model of the vehicle to estimate a reduction in lap time.

15. The method of claim 11 wherein:
prioritized coaching recommendations include corrective actions according to a driver-selected objective selected from the group consisting of minimal lap time, consistency and tire conservation.
